(19) United States
(12) Patent Application Publication
(10) Pub. No.: US 2009/0066987 A1
(43) Pub. Date: Mar. 12, 2009

(54) Image Forming Apparatus for Use in Backside Printing

(75) Inventor: Sumihiro Inokuchi, Kanagawa (JP)

Correspondence Address: IPUSA, P.L.L.C, 1054 31ST STREET, N.W., Suite 400, Washington, DC, 20007, US

(73) Assignee: RICOH COMPANY, LTD.

(21) Appl. No.: 12/207,543

(22) Filed: Sep. 10, 2008

(30) Foreign Application Priority Data
Sep. 12, 2007 (JP) 2007-236742
Jul. 30, 2008 (JP) 2008-196425

(51) Int. Cl. G06F 3/12

(52) U.S. Cl. 358/1.13

(57) ABSTRACT

An image forming apparatus includes an image obtaining unit configured to generate a document image for superimposition printing in response to an image requested to be printed or acquire the document image for superimposition printing from a source that requests printing, and an image recording unit configured to record the document image for superimposition printing as data associated with a paper sheet on which the requested image is printed.

### BACKGROUND OF THE INVENTION

1. Field of the Invention

The disclosures herein relate to an image forming apparatus such as an MFP (multifunction printer).

2. Description of the Related Art

For the purpose of resource saving and cost reduction, there has been an increasing number of users who use the blank side of print sheets to print images after the other side has already been used for printing. Such printing is sometimes referred to as “backside printing”. In most cases, print sheets are used for printing only on one side thereof, and will thereafter be discarded without being kept as a long lasting record. In consideration of such usage, backside printing can save a significant amount of paper sheet consumption.

There has also been an increasing number of incidents in which confidential information such as personal information is leaked, which has resulted in an increase in awareness for security. Leakage of confidential information may occur in the form of electronic data. Also, there has been a number of cases in which paper sheets bearing confidential information thereon (i.e., confidential documents) are improperly distributed.

Against this background, the problems associated with the use of backside printing are not related to information newly printed on the backside, but are related to the leakage of confidential information that has already printed on the other side. Most users do not check what information is printed on the other side of paper sheets when using the blank side of these paper sheets. If information that is newly printed on the blank side is not particularly confidential, these paper sheets may be later disposed of, without being shredded. As a result, the leakage of confidential information may inadvertently occur.

In consideration of such risks, Japanese Patent Application Publication No. 2001-228751 discloses technology for blacking out areas concerning confidential information at the time of backside printing when document information already printed on the other side is confidential.

FIGS. 1A and 1B are drawings showing examples of blacking out on the side of a paper sheet that bears confidential information at the time of backside printing. FIG. 1A illustrates an example in which a portion of one page is blacked out. When a character string CR printed on a print sheet PP is highlighted with a net pattern NE, a black pattern BL is printed over the net pattern NE to black out the confidential information. FIG. 1B illustrates an example in which the entirety of one page is blacked out. When a print sheet PP has a mark CD indicative of “FOR INTERNAL USE ONLY”, a black pattern BLH is printed all over the page to black out the confidential information.

The technology described above can prevent the leakage of confidential information by blacking out areas concerning confidential information on the printed-side of paper sheets at the time of backside printing. However, this technology may also black out areas needing no blacking out for the purpose of protecting confidential information, thereby ending up consuming excessive amount of toner. Even if the document is confidential, spaces between characters need not be blacked out. Also, there is no need to black out the entirety of a single character when this character is comprised of several parts. If all the spaces between characters or between character parts are to be blacked out, a large amount of toner will be consumed.

Accordingly, there is a need for an image forming apparatus that can prevent the leakage of confidential documents by using as little amount of toner as possible.

### SUMMARY OF THE INVENTION

It is a general object of at least one embodiment of the present invention to provide an image forming apparatus that substantially eliminates one or more problems caused by the limitations and disadvantages of the related art.

In one embodiment, an image forming apparatus includes an image obtaining unit configured to generate a document image for superimposition printing in response to an image requested to be printed or to acquire the document image for superimposition printing from a source that requests printing, and an image recording unit configured to record the document image for superimposition printing as data associated with a paper sheet on which the requested image is printed.

In another embodiment, an image forming apparatus includes an image obtaining unit configured to obtain a document image for superimposition printing associated with a paper sheet having a first side bearing a pre-printed image and a second side to be used for backside printing, and a print unit configured to print the obtained document image for superimposition printing over the pre-printed image printed on the first side of the paper sheet.

In an image forming apparatus according to at least one embodiment of the present invention, a document image for superimposition printing based on an image requested to be printed is generated or acquired from a source that requests printing, and is recorded as data associated with a paper sheet on which the requested image is printed. At the time of backside printing, the document image for superimposition printing associated with a paper sheet to be used for backside printing is obtained, and is printed on the pre-printed image printed on the paper sheet. With this arrangement, the document image for superimposition printing can make the pre-printed confidential information sufficiently illegible while containing blank areas unlike a solid pattern used in the conventional configuration. It is thus possible to reduce the amount of toner consumption while preventing the leakage of confidential information.

### BRIEF DESCRIPTION OF THE DRAWINGS

Other objects and further features of embodiments will be apparent from the following detailed description when read in conjunction with the accompanying drawings, in which:

FIGS. 1A and 1B are drawings showing examples of blacking out on the side of a paper sheet that bears confidential information at the time of backside printing;

FIG. 2 is a drawing showing an example of blacking out on the side of a paper sheet that bears confidential information at the time of backside printing according to an embodiment of the present invention;

FIGS. 3A through 3C are drawings showing examples of document images for superimposition printing;

FIG. 4 is a drawing showing the relationship between the amount of toner consumption and security levels according to image resolution for superimposition printing;

FIGS. 5A and 5B are drawings showing examples in which, RFID tags are used to record information in a paper sheet;

FIG. 6 is a drawing showing an example of the storing of a document image for superimposition printing in an image forming apparatus;

FIG. 7 is a functional block diagram showing an example of the configuration of an image forming apparatus according to an embodiment of the present invention;

FIG. 8 is a drawing showing an example of the configuration of a sheet travel path in the image forming apparatus;

FIG. 9 is a flowchart showing an example of the process of printing a confidential document;

FIG. 10 is a flowchart showing an example of the process of determining a security level and determining an image resolution and the number of expansion processes;

FIG. 11 is a flowchart showing an example of the process of printing a confidential document;

FIG. 12 is a flowchart showing an example of the process of performing backside printing; and

FIG. 13 is a drawing showing the determination of orientation of a paper sheet and the rotation of a document image for superimposition printing.

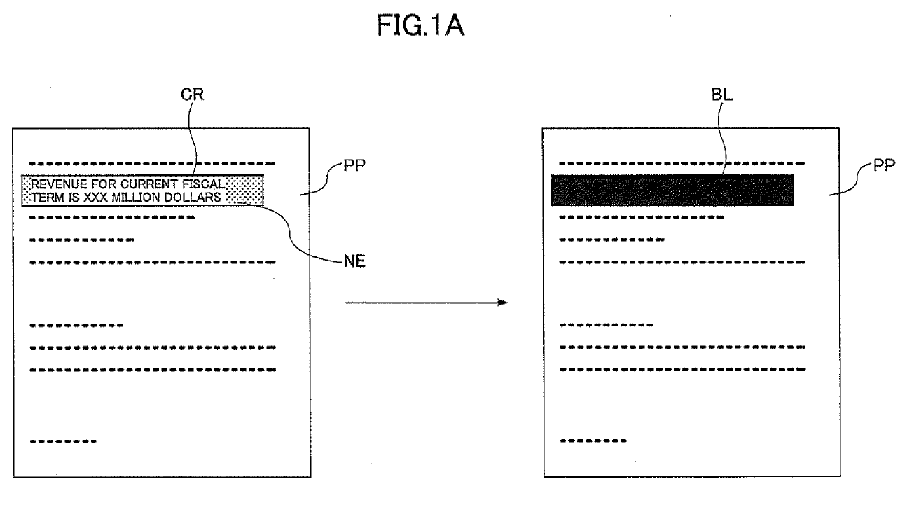

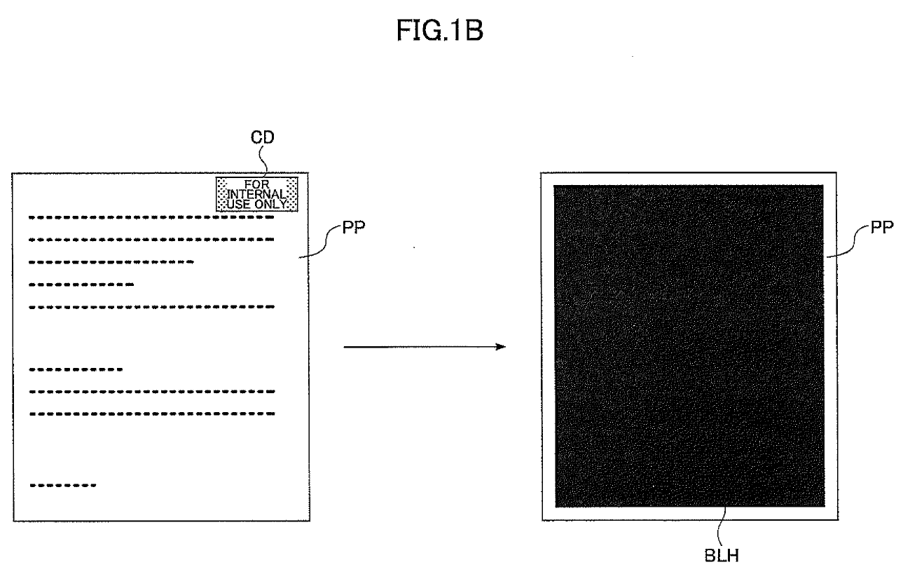

### DESCRIPTION OF THE PREFERRED EMBODIMENTS

In the following, embodiments of the present invention will be described with reference to the accompanying drawings.

<Outline of Superimposition Printing Over Confidential Document>

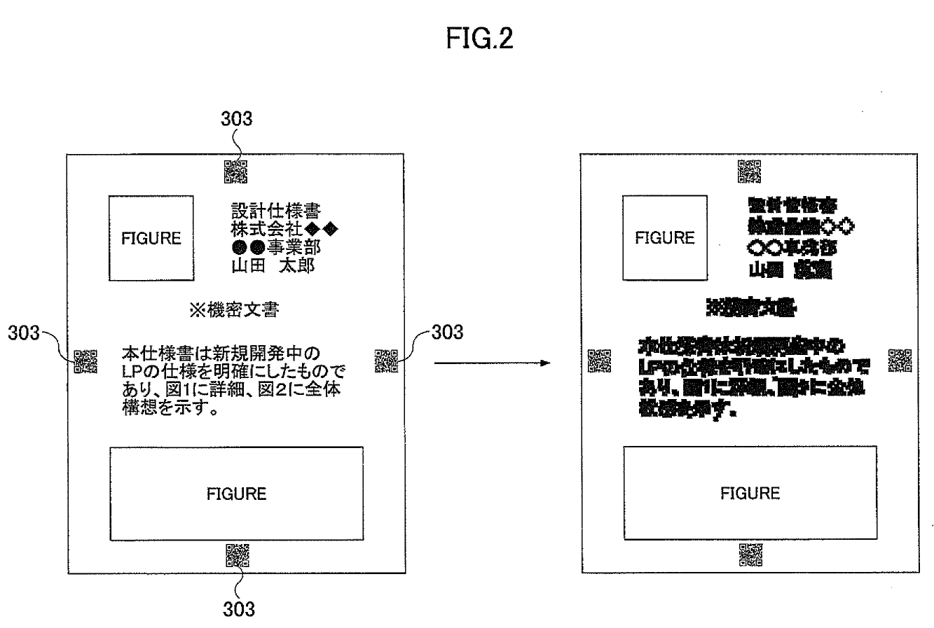

FIG. 2 is a drawing showing an example of blacking out on the side of a paper sheet that bears confidential information at the time of backside printing.

In this embodiment, QR codes 303 are printed separately from a confidential document at the centers of four margins at the top, bottom, left, and right of a paper sheet when the confidential document is printed. The QR codes 303 serve as code images inclusive of information regarding a document image for superimposition printing based on the confidential document image. The document image for superimposition printing included in the QR codes 303 may be a coarse image generated by reducing the image resolution of document contents printed on the paper sheet. Alternatively, such an image may be generated by performing an expansion process as many times as determined in advance with respect to the document contents printed on the paper sheet, such that the expansion process prints dots on all the eight pixels surrounding a dotted pixel of interest. Alternatively, such an image may be generated by performing both the reduction of image resolution and the expansion process. The document image for superimposition printing generated in this manner is converted into a QR code pattern, thereby generating image data for each of the QR codes 303. In general, the size of data representing a document image for superimposition printing is large. It is thus preferable to compress such data by use of a predetermined compression algorithm. Further, each of the QR codes 303 includes data for position information indicative of which one of the top, bottom, left, and right margins (edges) of a print paper bears the QR code of interest. The data for position information indicative of one of top, bottom, left, and right may be printed as a mark separate from each of the QR codes 303, rather than being included in each of the QR codes 303. The data for position information is used to align the orientation of the paper sheet and the orientation of the document image for superimposition printing, which will be described later in detail.

When the paper sheet is to be used for backside printing, the QR codes 303 on the side bearing confidential information are scanned to extract information from the QR codes 303 to generate a document image for superimposition printing. As shown on the right-hand side of FIG. 2, the document image for superimposition printing is then printed on the side on which the confidential information has been printed. After this, the duplex printing unit inside the apparatus reverses the paper sheet to allow printing to be performed on the blank side of the paper sheet. Alternatively, printing on the blank side of the paper sheet may be performed first, followed by reversing the paper sheet so that the document image for superimposition printing is printed. Alternatively, only the document image for superimposition printing is printed on the printed side, and printing on the blank side may thereafter be performed on a separate occasion.

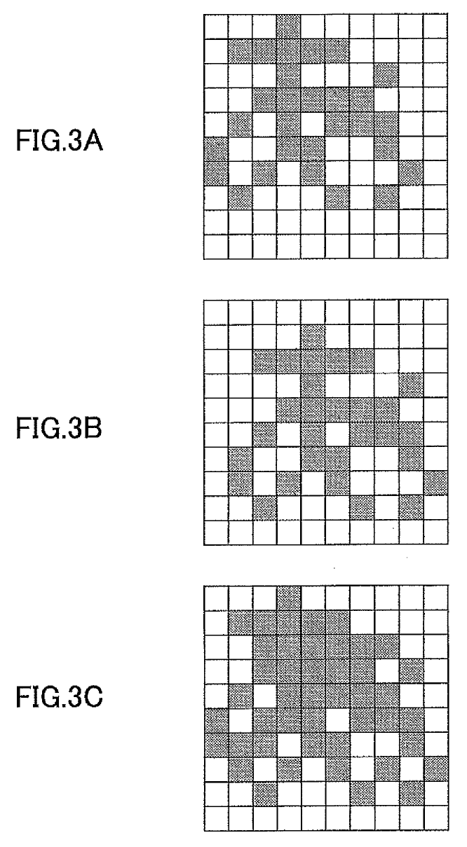

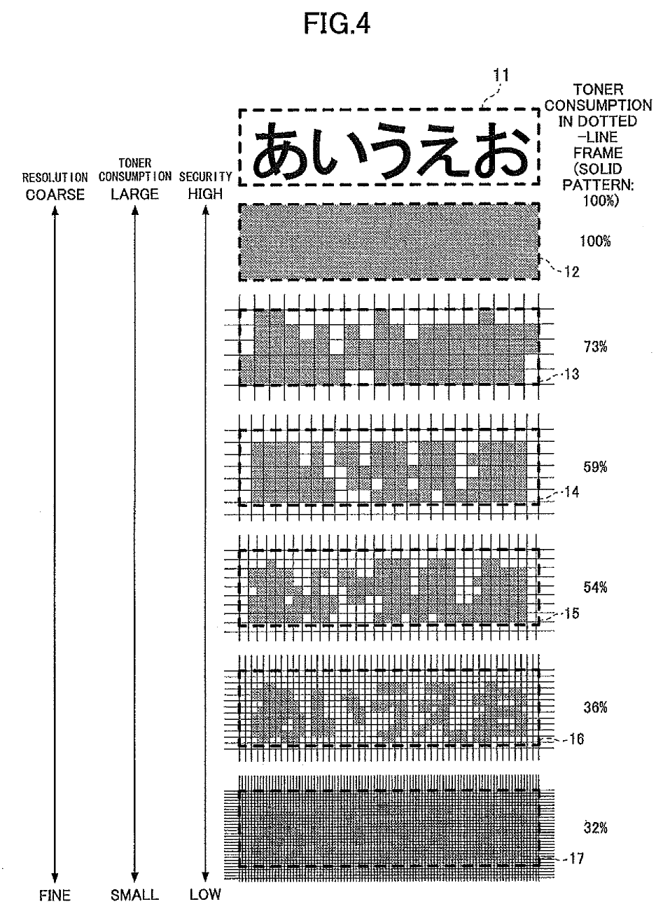

FIGS. 3A through 3C are drawings showing examples of document images for superimposition printing. The illustrated document images for superimposition printing are obtained by displacing a document image of confidential information in a predetermined direction. This method of generation may be used alone, or may be used in combination with the reduction of image resolution and/or the expansion process previously described. FIG. 3A is a drawing showing a Japanese character that is part of the document image including confidential information. It should be noted that this character is the leftmost letter shown on the top row in FIG. 4. The font image shown in FIG. 4A is displaced to the right by one pixel and then displaced downward by one pixel to generate the image shown in FIG. 4B, which is to be used as a document image for superimposition printing. When the document image for superimposition printing shown in FIG. 4B is printed on the document image shown in FIG. 4A, the document image shown in FIG. 4C is obtained. As can be seen from FIG. 4C, the original letter as shown in FIG. 4A is no longer legible.

A reduction in image resolution, the number of expansion processes, and/or the degree of image displacement may be adjusted according to the required security level. Through such adjustment, a proper document image for superimposition printing is obtained for the purpose of sufficiently altering the appearance of an original printed document image including confidential information. This makes it possible to prevent the leakage of confidential information while avoiding excessive toner consumption. The above-described arrangement can also be applicable to images such as photographs and graphical charts, and can make them unrecognizable by superimposing a document image for superimposition printing.

FIG. 4 is a drawing showing the relationship between the amount of toner consumption and security levels according to image resolution for superimposition printing.

An image 11 is an example of a character string that is already printed. The dotted-line frame is illustrated here for the purpose of evaluating the amount of toner consumption.

An image 12 is an example in which the area containing the character string is completely blacked out by a solid pattern as in the related-art configuration. The amount of tone consumption in the dotted-line frame is 100% in this case.

Images 13 through 17 are examples to which embodiments of the present invention are applied.

The image 13 is an example in which the characters are blurred by use of the coarsest image resolution. The amount of toner consumption in this case is 73% compared with the case of the related-art configuration. It is hard to discern what is written.

The image 14 is an example in which the characters are blurred by use of the second coarsest image resolution. The amount of toner consumption in this case is 59% compared with the case of the related-art configuration. It is still hard to discern what is written.

The image 15 is an example in which the characters are blurred by use of the third coarsest image resolution. The amount of toner consumption in this case is 54% compared with the case of the related-art configuration. It is still hard to discern what is written, but it is becoming possible to make out the outline.

The image 16 is an example in which the characters are blurred by use of the fourth coarsest image resolution. The amount of toner consumption in this case is 36% compared with the case of the related-art configuration. It is now possible to discern what is written.

The image 17 is an example in which the characters are blurred by use of the finest image resolution. The amount of toner consumption in this case is 32% compared with the case of the related-art configuration. It is possible to discern what is written.

As can be understood from these examples, as the image resolution decreases (with increased dot size), the amount of toner consumption increases, but the security level increases. In FIG. 4, the relationship between the amount of toner consumption and the security level is shown as a function of image resolution. This relationship between the amount of toner consumption and the security level varies depending on how a document image for superimposition printing is generated, such as by performing a predetermined number of expansion processes alone, performing image displacement alone, or performing these processes in combination. The method of generating a document image for superimposition printing may be selected in advance separately for each of the security levels required for confidential documents. Such arrangement can achieve the optimum amount of toner consumption while preventing the leakage of confidential information. It should be noted that the reduction in toner consumption is not the only objective that needs to be achieved. What is important is to strike a balance between the amount of toner consumption, the security level, and user preference.

It should be noted that an image already printed on a paper sheet is not limited to any particular image, and can be any type of image. From the viewpoint of utilizing the present invention for the purpose of providing security, such image may be those including confidential information such as information for internal use only (for inside company or for inside a particular division) which may be customer information, employee information, contract related information, tax related information, research and development related information, etc.

The image forming apparatus is only required to print a document image for superimposition printing. Such image forming apparatus may be any type of apparatus capable of forming a desired image such as a copier, a printer, a facsimile device with an additional function for performing the required superimposition printing. Alternatively, the image forming apparatus may be an apparatus dedicated for printing a document image for superimposition printing on an already-printed paper sheet.

The QR codes 303 are printed at the centers of the top, bottom, left, and right margins (edges) of a paper sheet as shown in FIG. 2A in order to reduce the number of QR code readers that are needed to scan the QR codes 303, thereby achieving cost reduction. Namely, the provision of the QR codes 303 at the four centers of the top, bottom, left, and right margins (edges) makes it possible for a single QR code reader situated at the center to detect a QR code 303 regardless of the orientation and size of the paper sheet. Such an arrangement can reduce cost. The positions of the QR codes 303 may not be limited to the centers of the four margins of a paper sheet, but may vary according to need. Further, the QR codes 303 may be printed as many times as desired on a paper sheet. If there is no restriction on the arrangement and number of QR code readers, and the orientation of a paper sheet can be detected by some other means, then, it may suffice to provide only one QR code 303 on a paper sheet. In this case, the QR code 303 does not need to include position information. The QR code 303 may be situated at a position diverted from the center on a paper sheet. With this arrangement, the orientation of the paper sheet can be detected based on the relative position of the detected OR code 303 on the paper sheet. Alternatively, the orientation of a paper sheet may be detected by scanning letters printed on the paper sheet and then performing optical character recognition.

Further, a code image printed on a paper sheet is not limited to a QR code 303, but may be a barcode or magnetic information recorded in a magnetic strip attached at a predetermined position on a printed paper sheet. With the use of a magnetic strip, a magnetic sensor or the like may be used as a reader (scanner). Alternatively, an REID (radio frequency identification) tag may be attached to a paper sheet or embedded in a paper sheet to store a document image for superimposition printing and the like. Here, the RFID tag is a small IC chip provided with a data recording function and a radio communication function, which allow data to be written to and read from the tag.

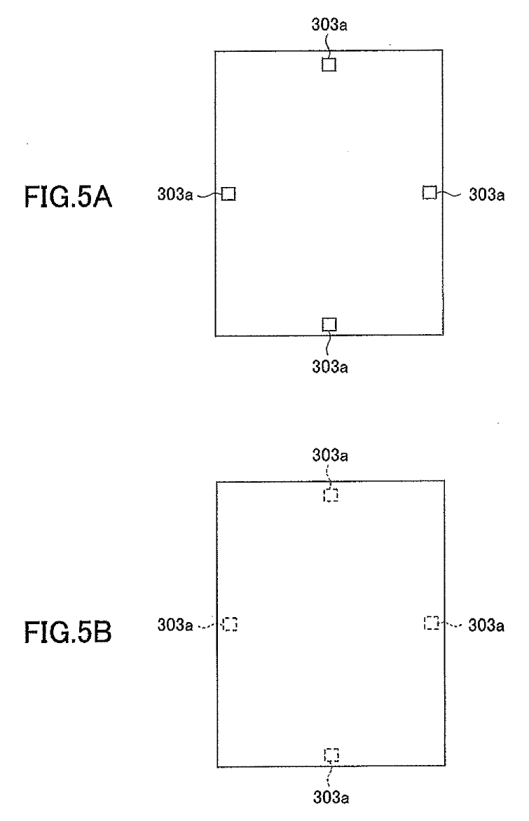

FIGS. 5A and 5B are drawings showing examples of RFID tags used with a paper sheet for storing information. FIG. 5A shows REID tags 303a attached to a paper sheet at the centers of its top, bottom, left, and right margins (edges). FIG. 5R shows RFID tags 303a embedded in a paper sheet at the centers of its top, bottom, left, and right margins (edges). As in the case of the QR codes 303 previously described, the number of the RFID tags 303a is not limited to any particular number. When the RFID tags 303a are used, it is possible to read data regardless of whether the paper sheet is showing its front side or back side. There is thus a need to detect whether a front side of a paper sheet is shown or a back side of a paper sheet is shown. For example, an image on a paper sheet may be scanned roughly to check whether the printed side of the paper sheet is shown.

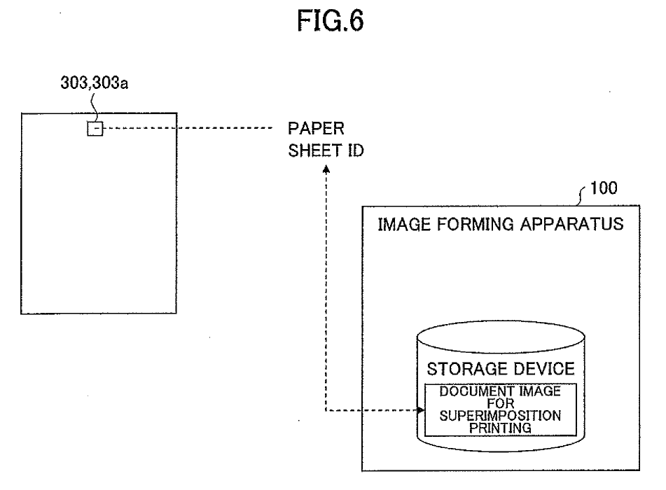

The above description has been provided with respect to a case in which a document image for superimposition printing is recorded in the QR codes 303 or RFID tags 303a. All that is necessary, however, is to record a document image for superimposition printing and associating it with a paper sheet which is to be printed. A document image for superimposition printing may properly be stored separately from a paper sheet. FIG. 6 is a drawing showing an example in which a document image for superimposition printing is stored in an image forming apparatus. In this example, the QR code 303 or RFID tag 303a provided on a paper sheet stores a sheet ID for identifying the paper sheet. A document image for superimposition printing associated with this sheet ID is stored in a memory storage provided in an image forming apparatus 100.

Information recorded on a paper sheet as a code image may also include an expiration date in addition to the data of a document image for superimposition printing. Some confidential information may not be confidential any longer after passage of a certain time period, such as after the publication of documents. An expiration data may be set for such confidential information. After the expiration date, a paper sheet bearing this confidential information may be used for ordinary backside printing without printing a document image for superimposition printing. This arrangement can avoid excessive toner consumption.

In place of providing a document image for superimposition printing as a code image such as the QR codes 303, an image already printed on a paper sheet may be scanned at the time of backside printing to generate a document image for superimposition printing. In this case, an image reader provided in a scanner or facsimile apparatus may be utilized for this purpose. Information on a printed paper sheet is scanned first, so that a document image for superimposition printing is generated with respect to areas where confidentiality is high. The operator then feeds the paper sheet to the apparatus again to print the document image for superimposition printing over these areas.

<Apparatus Configuration>

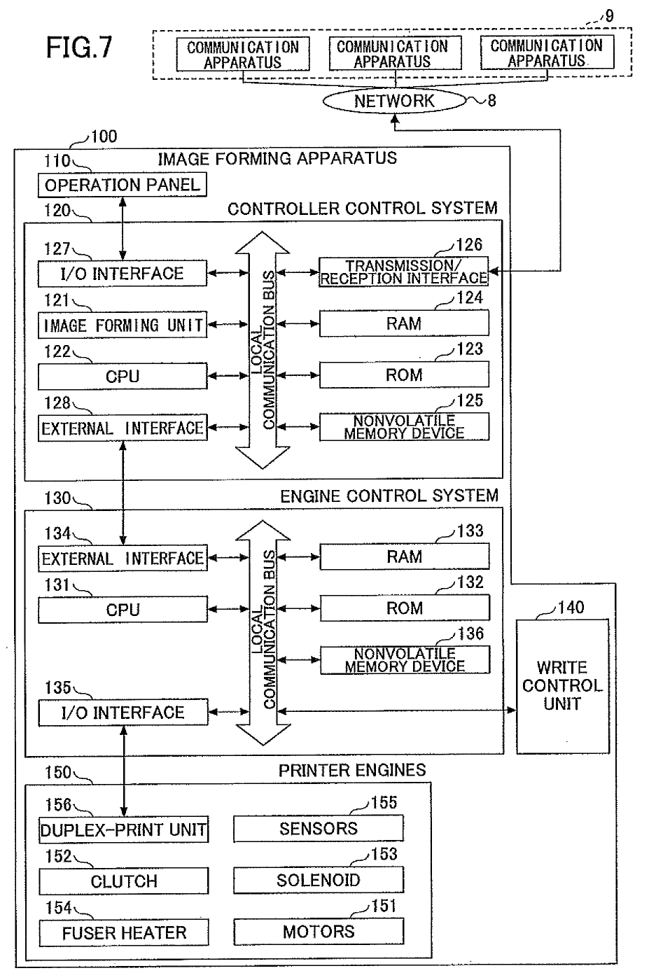

FIG. 7 is a functional block diagram showing an example of the configuration of an image forming apparatus according to an embodiment of the present invention.

In FIG. 7, the control system of an image forming apparatus 100 provided with a digital copy function includes a controller control system 120 for setting an image forming operation in response to a request indicative of the image forming operation, and also includes an engine control system 130 for controlling the driving of printer engines 150. To be specific, the controller control system 120 attends to the control of image forming operation, user interface, mode setting, applications such as a copy application and a printer application, etc.

The controller control system 120 includes an image forming unit 121 comprised of an ASIC (Application Specific Integrated Circuit) and the like for performing an image forming processor a CPU (Central Processing Unit) 122 for performing various processes, a ROM (Read Only Memory) 123 for storing control programs in a nonvolatile manner, a RAM (Random Access. Memory) 124 for storing various types of information in a volatile manner, a nonvolatile memory device 125 for storing setting information indicative of operating conditions concerning the digital copier, a transmission/reception interface 126 for transmitting and receiving information to and from an external communication apparatus 9 via a network 8 such as a LAN (Local Area Network), an I/O (input/output) interface 127 for providing an interface for an operation panel 110 and a serial communication line, and an external interface 128 for communicating with the engine control system 130. These units are connected together through a local communication bus.

The controller control system 120 receives a request to perform an image forming operation from the operation panel 110 or from the external communication apparatus 9. In response to the request, the controller control system 120 makes settings specifying the image forming operation, and transmits these settings to the engine control system 130.

The engine control system 130 includes a CPU 131 for performing various processes, a ROM 132 for storing control programs in a nonvolatile manner, a RAM 133 for storing various types of information in a volatile manner, an external interface 134 for communicating with the controller control system 120, an I/O interface 135 for reading information from the printer engines 150, and a nonvolatile memory device 136 for storing minimum necessary setting information regarding operating conditions required to start a preparation operation for printer engines after power on. These units are connected together through a local communication bus.

Image data generated by the image forming unit 121 of the controller control system 120 is sent to the external interface 134 of the engine control system 130 via the external interface 128 of the controller control system 120. The engine control system 130 then sends the image data to a write control unit 140 to print an image.

The printer engines 150 include motors 151, a clutch 152, a solenoid 153, a fuser heater 154, sensors 155, and a duplex-print unit 156.

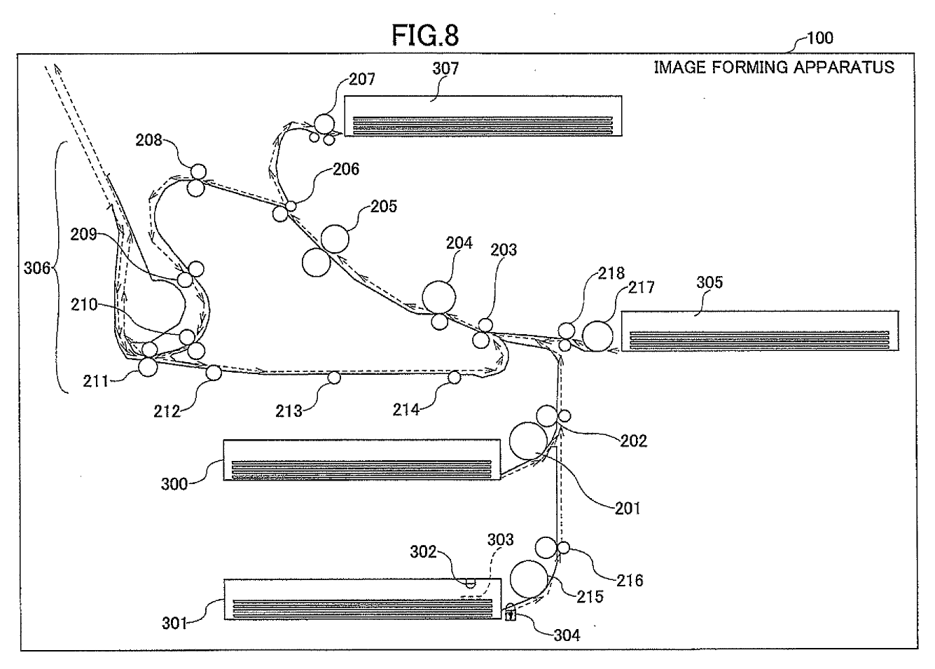

FIG. 8 is a drawing showing an example of the configuration of a sheet travel path in the image forming apparatus.

In FIG. 8, the image forming apparatus 100 is provided with the function to perform duplex printing on both sides of a paper sheet. The image forming apparatus 100 includes a confidential tray 301 for storing various confidential documents, a QR code reader 302 for detecting the QR codes 303 of a paper sheet supplied from the confidential tray 301, a confidential tray dedicated lock 304 for locking the confidential tray 301, and a duplex-printing unit 306 for reversing a paper sheet. Even if the duplex-printing unit 306 is not provided to allow duplex printing through the reversing of paper sheet in a series of continuous operations, the present invention is still applicable by manually inserting and reversing a paper sheet. Further, the function to perform duplex printing is not necessary when only superimposition printing is performed over confidential information printed on a paper sheet as a confidential information purging operation, separately from backside printing.

In FIG. 8, when a confidential document is to be newly printed, a paper sheet is supplied from a paper feed tray 300 via a paper feed roller 201 and a relay roller 202. After passing through resist rollers 203, a confidential document and QR codes 303 are printed on the paper sheet by a transfer roller 204. Here, the QR codes 303 include the data of a document image for superimposition printing generated by the image forming unit 121 (see FIG. 7). Fuser rollers 205 then fuse images on the paper sheet, which is then discharged onto a catch tray 307 via sheet discharging rollers 207.

When this paper sheet bearing the confidential document printed thereon is to be used for backside printing, the paper sheet bearing the confidential document is set in the confidential tray 301, which is then locked by use of the confidential tray dedicated lock 304. With this arrangement, the user can safely store away the paper sheet in the confidential tray 301 without shredding it. Two problems with a shredder are that it is expensive and it occupies office space. Also, shredded paper sheets make it difficult to separate toner from paper in a recycling process. The arrangement described above can eliminate these problems.

When the paper sheet bearing a confidential document is to be used for backside printing, the QR code reader 302 detects the QR codes 303 printed on the paper sheet in the confidential tray 301. The document image for superimposition printing included in the QR codes 303 is then reconstructed by the controller control system 120. The document image for superimposition printing is sent to the engine control system 130 via the external interface 128, and, then, is sent to the write control unit 140 from the engine control system 130. The transfer roller 204 prints the document image for superimposition printing on the paper sheet.

After this, the paper sheet travels to the duplex-printing unit 306 via fuser discharge rollers 206 where the paper sheet is placed in a nipped state between paper feed rollers 211. In this state, the paper feed rollers 211 are rotated in a reverse direction to switch back the paper sheet, so that the paper sheet is sent to the resist rollers 203 via a horizontal conveyer roller (driven) 212, a horizontal conveyer roller (center) 213, and a horizontal conveyer roller (right) 214. The paper sheet travels again through the paper travel path toward the transfer roller 204, which then prints an image on the other side of the paper sheet different from the side that was printed the first time. After this, the paper sheet is discharged onto the catch tray 307 via the sheet discharging rollers 207.

The reason why the QR code reader 302 is installed inside the confidential tray 301 is to transmit the data to the controller control system 120 before the feeding of the paper sheet starts. This arrangement can hide the delay associated with the scanning of the QR codes 303 at the time of printing. If there is no need to take into consideration the delay associated with the scan, the QR code reader 302 may properly be installed somewhere else. The QR code reader 302 may be installed at a position immediately upstream relative to the resist rollers 203, for example. With such provision, the delay associated with the scanning of the QR codes 303 on the paper sheet may not be ignored. However, even if a paper sheet bearing confidential information is misplaced in a tray other than the confidential tray 301, the QR code reader 302 can properly detect the incoming paper sheet as a sheet bearing confidential information to attend to proper processing. Further, the QR code readers 302 may be provided on both sides of a paper sheet (i.e., over and under the illustrated travel path) at a position immediately upstream from the resist rollers 203. In this case, a paper sheet bearing confidential information can properly be detected by the QR code readers 302 even if the paper sheet is misplaced as to its direction (i.e., face-up or face-down) in the confidential tray 301. When such misplacement is detected, a requested document image is first printed by the transfer roller 204 on the paper sheet. The duplex-printing unit 306 then reverses the paper sheet, so that the transfer roller 204 prints the document image for superimposition printing on the other side of the paper sheet. After this, the paper sheet is discharged onto the catch tray 307 via the sheet discharging rollers 207.

This embodiment has been described with respect to an example in which a document image for superimposition printing is first printed on the side where confidential information has been printed. As has just been described, however, a new document image may be printed on a paper sheet first, which is then reversed for the printing of a document image for superimposition printing over the confidential information prior to paper discharge. In this case, reversal by the duplex-printing unit 306 and subsequent processing are not performed if the paper sheet for backside printing is not a paper sheet with confidential information.

The confidential tray dedicated lock 304 provided to the confidential tray 301 may be a lock mechanism with a physical key. Alternatively, the confidential tray dedicated lock 304 may utilize a password-based electronic key system or fingerprint-based identification system.

Further, the catch tray 307 may be divided into sections onto which paper sheets are discharged according to whether the other side bears confidential information. This allows users to visually check whether the confidential information is sufficiently blurred to be illegible.

<Printing Operating>

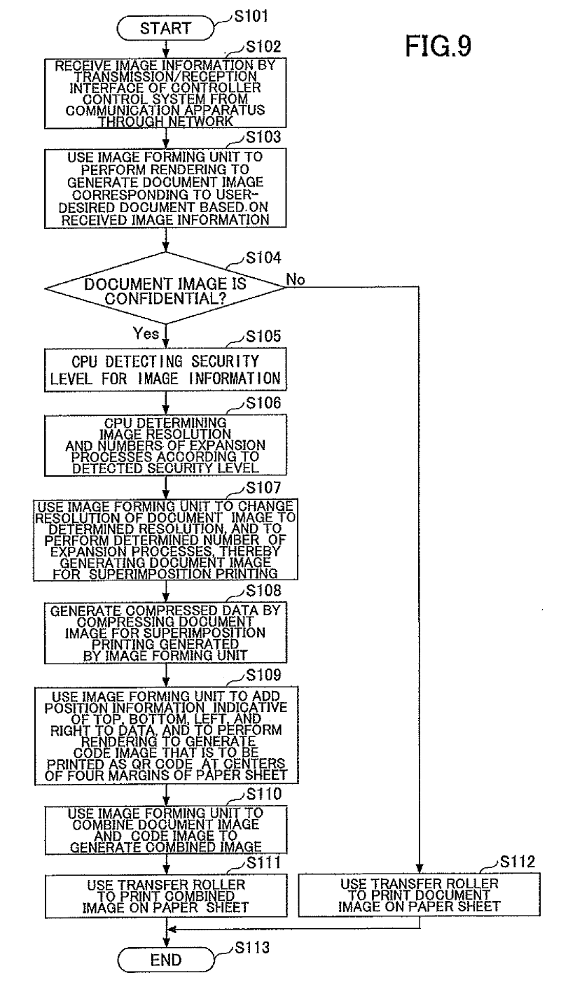

FIG. 9 is a flowchart showing an example of the process of printing a confidential document.

In step S101, the process of printing a confidential document starts. At the external communication apparatus 9 used by a user, the user specifies whether the document is a confidential document, what security level is to be used for this confidential document, etc., in a dialogue box displayed by a printer driver in response to a request to print the document. In step S102, the image forming apparatus 100 uses the transmission/reception interface 126 of the controller control system 120 to receive image information inclusive of various specified indications from the external communication apparatus 9 via the network B. The indications as to whether the document is confidential and what security level is to be used may not need to be specified by the user, and may alternatively be set automatically by the image forming apparatus 100 without user intervention. In such a case, document types (e.g., confidential report, customer information) and security levels associated with respective confidential documents are stored in the ROM 123 or the like in advance by the controller control system 120 of the image forming apparatus 100. The controller control system 120 determines whether a document of interest is confidential based on the received image information, and also determines a proper security level if the document is determined to be confidential. The setting of a security level will later be described.

The user can also specify whether the confidential area is part of the document to be printed or the entirety of the document. If the confidential information is to be printed only on part of a paper sheet as in the case of individual names, the user may specify the confidential area through a mouse drag operation. The controller control system 120 may detect the print portions within the specified area, and performs superimposition printing only on those detected portions to reduce the amount of toner consumption.

In step S103, the image forming unit 121 of the controller control system 120 performs rendering to generate a document image representing a user desired document based on the received image information. The term “rendering” refers to a process that generates an image through computation based on information indicative of the contents to be printed that is supplied as numerical data.

In step S104, the CPU 122 of the controller control system 120 checks based on the image information whether the document to be printed is a confidential document. Such a check is performed based on the user-specified indication as to whether the document is confidential, or is performed based on the document type. If the document to be printed is not confidential, the document image is printed on a paper sheet by the transfer roller 204 in step S112. The sheet discharging rollers 207 then discharge the paper sheet onto the catch tray 307. In step S113, the printing process comes to an end.

If the CPU 122 of the controller control system 120 determines that the document to be printed is confidential, the CPU 122 determines a security level in step S105. Such a determination is made based on the user-specified indication of a security level to be used, or is made based on the data automatically specified by the controller control system 120. In step S106, the CPU 122 determines an image resolution and the number of expansion processes that are used to generate a coarse image in response to the determined security level.

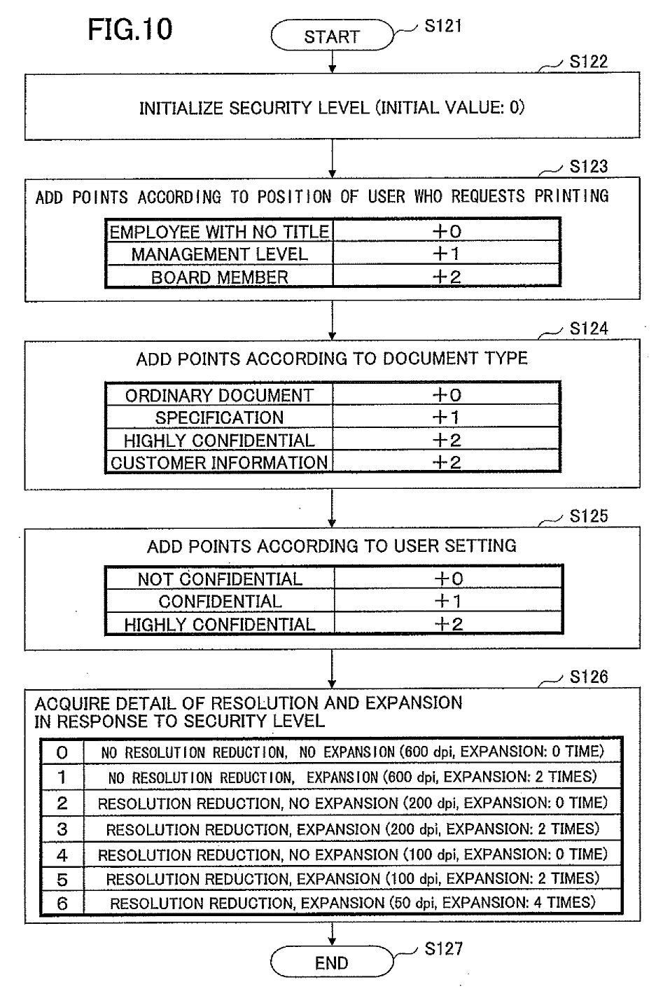

FIG. 10 is a flowchart showing an example of the process of determining a security level and determining an image resolution and the number of expansion processes. This process corresponds to steps S105 and S106 shown in FIG. 9. In step S121 of FIG. 10, the process starts. In step S122, the security level is set to “0” as an initial setting. In step S123, points are added in accordance with the position of the user who has requested to print the document. For example, no point may be added if the user is an employee with no title. One point may be added if the user's position is at management level. Two points may be added if the user is a board member. The position of the user may be determined by referring to a user database based on the user ID.

In step S124, points are added in accordance with document types. For example, no point may be added if the document is an “ordinary document”. One point may be added if the document is a “specification”. Two points may be added if the document is a “customer information document”. The document type may be determined based on information attached to the document, or may be determined by referring to a document management database or the like.

In step S125, points are added in accordance with user settings. For example, no point may be added if the user setting indicates “no confidential information”. One point may be added if the user setting indicates “confidential information” Two points may be added if the user setting indicates “highly confidential information”.

In step S126, the specifics of image resolution reduction and expansion processes are obtained in accordance with the security level. For example, the security level “0” means no reduction in image resolution and no expansion process (600 dpi, and expansion process: 0). The security level “1” means no reduction in image resolution and some expansion process (600 dpi, and expansion process: 2 times). The security level “2” means some reduction in image resolution and no expansion process (200 dpi, and expansion process: 0) The security level “3” means some reduction in image resolution and some expansion process (200 dpi, and expansion process: 2 times). The security level “4” means some reduction in image resolution and no expansion process (100 dpi, and expansion process: 0). The security level “5” means some reduction in image resolution and some expansion process (100 dpi, and expansion process: 2 times). The security level “6” means some reduction in image resolution and some expansion process (50 dpi, and expansion process: 4 times). In step S127, the procedure comes to an end.

Referring to FIG. 9 again, in step S107, the image forming unit 121 converts the image resolution of the document image and performs expansion processes according to the determined image resolution and the determined number of expansion processes, thereby generating a document image for superimposition printing. The document image for superimposition printing may be generated as a color image. For the purpose of concealing existing print characters, however, a monochrome image may be more preferable.

In step S108, the image forming unit 121 compresses the document image for superimposition printing to generate compressed data.

In step S109, the image forming unit 121 adds position information indicative of top, bottom, left, or right to the compressed data, and performs rendering to generate code images to be printed as the QR codes 303 at the centers of margins (edges) of a paper sheet.

In step S110, the image forming unit 121 generates a combined image by combining the document image of the confidential document to be printed and the code images.

In step S111, the combined image is printed on a paper sheet by the transfer roller 204. The sheet discharging rollers 207 then discharge the paper sheet onto the catch tray 307. In step S113, the printing process comes to an end.

In the above-described example, the image forming apparatus 100 performs image resolution conversion, expansion, and compression in steps S107 and 8108. Alternatively, the external communication apparatus 9 requesting the printing of the document may perform these processes, and may transmit the data after these processes to the image forming apparatus 100. The transmission/reception interface 126 of the controller control system 120 of the image forming apparatus 100 may receive such data, followed by the rendering of code images by the image forming unit 121 as performed in step S109. Alternatively, the external communication apparatus 9 requesting the printing of the document may further generate the combined image, so that the image forming apparatus 100 simply prints the received combined image.

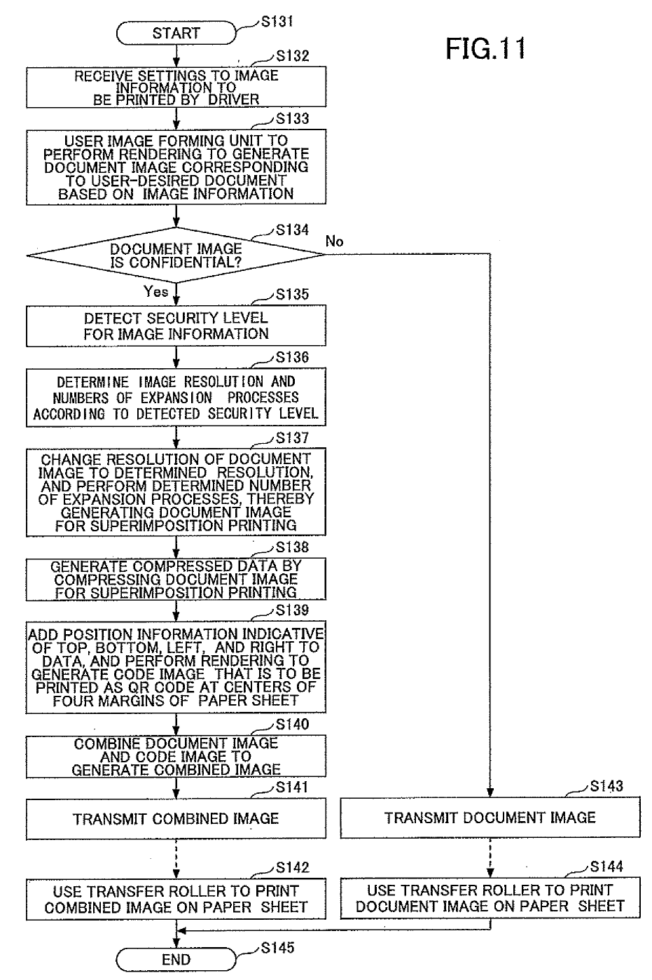

FIG. 11 is a flowchart showing an example of the process of printing a confidential document. In this example, the external communication apparatus 9 performs all the processes up to the generation of a combined image.

In step S131 of FIG. 11, the process starts. In step S132, the driver of the external communication apparatus 9 receives settings concerning image information to be printed from the user.

In step S133, the driver performs rendering to generate a document image representing a user desired document based on the image information.

In step S134, the driver checks based on the image information whether the document to be printed is a confidential document. Such a check is performed based on the user-specified indication as to whether the document is confidential, or is performed based on the document type. If the document to be printed is not confidential, the document image is transmitted to the image forming apparatus 100 in step S143. In step S144, the image forming apparatus 100 prints the document image on a paper sheet by use of the transfer roller 204. The sheet discharging rollers 207 then discharge the paper sheet onto the catch tray 307. In step S145, the printing process comes to an end.

If it is ascertained that the document to be printed is confidential, the driver determines a security level in step S135. Such determination is made based on the user-specified indication of a security level to be used, or is made based on the data automatically specified by the driver. In step S136, the driver determines an image resolution and the number of expansion processes that are used to generate a coarse image in response to the determined security level.

In step S137, the driver converts the image resolution of the document image and performs expansion processes according to the determined image resolution and the determined number of expansion processes, thereby generating a document image for superimposition printing.

In step S138, the driver compresses the document image for superimposition printing to generate compressed data.

In step S139, the driver adds position information indicative of top, bottom, left, or right to the compressed data, and performs rendering to generate code images to be printed as the QR codes 303 at the centers of margins (edges) of a paper sheet.

In step S140, the driver generates a combined image by combining the document image of the confidential document to be printed and the code images.

In step S141, the combined image is transmitted to the image forming apparatus 100. In step S142, the image forming apparatus 100 prints the combined image on a paper sheet by use of the transfer roller 204. The sheet discharging rollers 207 then discharge the paper sheet onto the catch tray 307. In step S145, the printing process comes to an end.

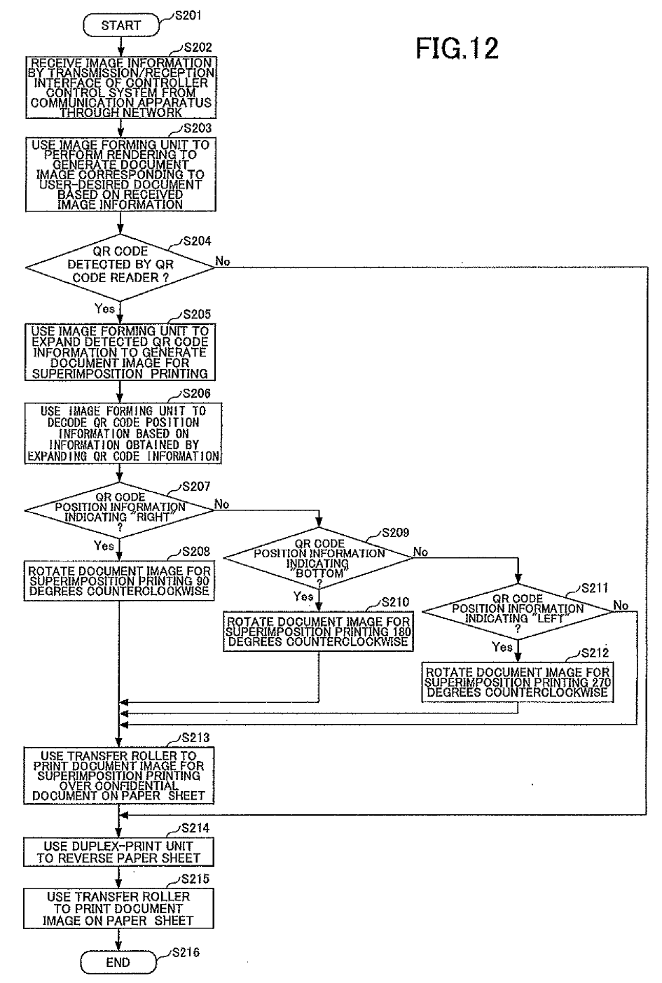

FIG. 12 is a flowchart showing an example of the process of performing backside printing.

In step S201, the process of performing backside printing starts. At the external communication apparatus 12 used by a user, the user specifies a document to be printed to request printing. In step S202, the image forming apparatus 100 uses the transmission/reception interface 126 of the controller control system 120 to receive image information from the external communication apparatus 9 via the network 8.

In step S203, the image forming unit 121 of the controller control system 120 performs rendering to generate a document image representing a user desired document based on the received image information.

In step S204, the CPU 122 of the controller control system 120 checks whether the QR code reader 302 detects the QR codes 303 provided on a paper sheet. If the QR codes 303 are not detected, the duplex-printing unit 306 is used to reverse the paper sheet in step S214. In step S215, the document image is printed on the paper sheet by use of the transfer roller 204. The sheet discharging rollers 207 then discharge the paper sheet onto the catch tray 307. In step S216, the printing process comes to an end.

If the QR codes 303 are detected, the image forming unit 121 expands the information embedded in the QR codes 303 to generate (reconstruct) a document image for superimposition printing in step S205.

In step S206, the image forming unit 121 recognizes position information included in the QR codes 303 based on the information obtained by expanding the QR code information.

In step S207, the CPU 122 checks whether the position information of the QR codes 303 indicates “right”. If “right” is indicated, the document image for superimposition printing is rotated 90 degrees counterclockwise in step S208. If the position information of the QR codes does not indicate “right”, the CPU 122 checks whether the position information of the QR codes 303 indicates “bottom” in step S209. If “bottom” is indicated, the document image for superimposition printing is rotated 180 degrees counterclockwise in step S210. If the position information of the QR codes 303 does not indicate “bottom”, the CPU 122 checks whether the position information of the QR codes 303 indicates “left” in step S211. If “left” is indicated, the document image for superimposition printing is rotated 270 degrees counterclockwise in step S212. If the position information of the QR codes 303 does not indicate “left”, no rotation of the document image for superimposition printing is performed.

In step S213, the document image for superimposition printing is printed in a superimposing fashion by use of the transfer roller 204 on the side of the paper sheet on which the confidential document is printed. In step S214, the duplex-printing unit 306 is used to reverse the paper sheet. In step S215, the document image requested to be printed is printed on the paper sheet by use of the transfer roller 204. The sheet discharging rollers 207 then discharge the paper sheet onto the catch tray 307. In step S216, the printing process comes to an end.

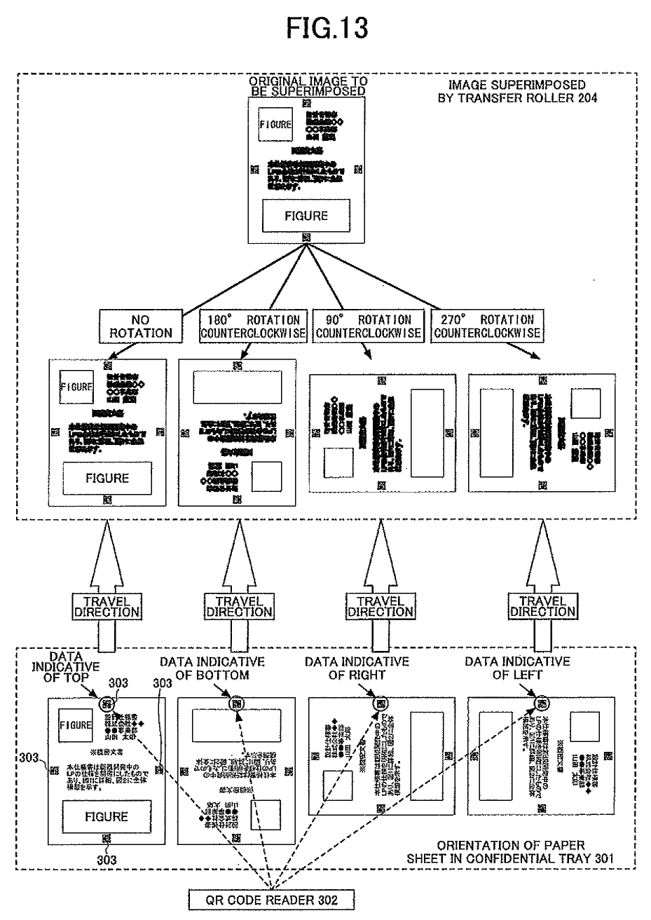

FIG. 13 is a drawing showing the determination of orientation of a paper sheet and the rotation of a document image for superimposition printing. FIG. 13 illustrates the processes of steps S207 through S212 of FIG. 12 in more detail.

In the embodiments described above, the QR codes 303 are detected to align a document image for superimposition printing to the original print image regardless of the orientation in which the paper sheet is placed when the paper sheet bearing confidential information is used for backside printing. With this arrangement, the user does not need to be conscious of the orientation of a paper sheet bearing confidential information when setting the paper sheet for use in backside printing. FIG. 13 illustrates how this is achieved.

As shown in a dotted-line box indicated as “ORIENTATION OF PAPER SHEET IN CONFIDENTIAL TRAY 301” at the bottom of FIG. 13, the QR codes 303 are provided in the center of the top, bottom, left, and right margins, and contain data indicative of top, bottom, left, and right, respectively. With this provision, the QR code reader 302 arranged at the center position can detect the QR codes 303 regardless of the orientation and size of a paper sheet.

The paper sheet travels in the direction indicated by arrows shown in FIG. 13, and the transfer roller 204 superimposes an image. If the document image for superimposition printing is printed while being placed in the orientation shown as “ORIGINAL IMAGE TO BE SUPERIMPOSED” in the dotted-line box “IMAGE SUPERIMPOSED BY TRANSFER ROLLER 204” at the top of FIG. 13, the printed images may not be aligned due to the placement of the paper sheet in a wrong orientation (i.e., the paper sheet placed upside down or placed at 90 degree angle). In order to avoid this, the data indicative of top, bottom, left, and right provided as part of the OR codes 303 is scanned by the QR code reader 302, so that the image forming unit 121 detects the data indicative of top, bottom, left, and right. Based on the detected data, rotational correction is performed as follows:

in the case of the data indicative of top, the original image to be superimposed is maintained at its current orientation;

in the case of the data indicative of bottom, the original image to be superimposed is rotated 180 degrees counterclockwise;

in the case of the data indicative of right, the original image to be superimposed is rotated 90 degrees counterclockwise; and

in the case of the data indicative of left, the original image to be superimposed is rotated 270 degrees counterclockwise.

After the correction process as described above, the original image to be superimposed as rotated or maintained at its original orientation is printed on the paper sheet, so that the document image for superimposition printing is properly aligned to and printed over the printed confidential information.

Embodiments of the present invention have been described heretofore for the purpose of illustration. The present invention is not limited to these embodiments, but various variations and modifications may be made without departing from the scope of the present invention. The present invention should not be interpreted as being limited to the embodiments that are described in the specification and illustrated in the drawings.

The present application is based on Japanese priority applications No. 2007-236742 filed on Sep. 12, 2007, and No. 2008-196425 filed on Jul. 30, 2008, with the Japanese Patent Office, the entire contents of which are hereby incorporated by reference.

What is claimed is:

1. An image forming apparatus, comprising:
an image obtaining unit configured to generate a document image for superimposition printing in response to an image requested to be printed or acquire the document image for superimposition printing from a source that requests printing; and
an image recording unit configured to record the document image for superimposition printing as data associated with a paper sheet on which the requested image is printed.

2. The image forming apparatus as claimed in claim 1, wherein the document image for superimposition printing is generated by reducing an image resolution of the image requested to be printed.

3. The image forming apparatus as claimed in claim 1, wherein the document image for superimposition printing is generated by performing an expansion process with respect to the image requested to be printed.

4. The image forming apparatus as claimed in claim 1, wherein the document image for superimposition printing is generated by displacing the image requested to be printed in a predetermined direction.

5. The image forming apparatus as claimed in claim 2, wherein the document image for superimposition printing is generated in such a manner that a difference between the document image for superimposition printing and the image requested to be printed varies in response to a security level required for the image requested to be printed.

6. An image forming apparatus, comprising:
an image obtaining unit configured to obtain a document image for superimposition printing associated with a paper sheet having a first side bearing a pre-printed image and a second side to be used for backside printing; and
a print unit configured to print the obtained document image for superimposition printing over the pre-printed image printed on the first side of the paper sheet.

7. The image forming apparatus as claimed in claim 6, wherein the document image for superimposition printing associated with the paper sheet is directly recorded in the paper sheet.

8. The image forming apparatus as claimed in claim 6, wherein the document image for superimposition printing associated with the paper sheet is recorded in the image forming apparatus as data associated with a paper sheet identification that is directly recorded on the paper sheet.

9. The image forming apparatus as claimed in claim 7, wherein said direct recording in the paper sheet is performed by printing a code image on the paper sheet

10. The image forming apparatus as claimed in claim 7, wherein said direct recording in the paper sheet is performed by recording information in an RFID tag provided in the paper sheet

11. The image forming apparatus as claimed in claim 6, wherein the document image for superimposition printing is generated based on an image scanned from the first side of the paper sheet.

12. A method of controlling an image forming process, comprising:
an image obtaining step of generating a document image for superimposition printing in response to an image requested to be printed or acquiring the document image for superimposition printing from a source that requests printing; and
an image recording step of recording the document image for superimposition printing as data associated with a paper sheet on which the requested image is printed.

13. A method of controlling an image forming process, comprising:
an image obtaining step of obtaining a document image for superimposition printing associated with a paper sheet having a first side bearing a pre-printed image and a second side to be used for backside printing; and
a print step of printing the obtained document image for superimposition printing over the pre-printed image printed on the first side of the paper sheet.
